(19) United States
(12) Patent Application Publication
(10) Pub. No.: US 2025/0371837 A1
(43) Pub. Date: Dec. 4, 2025

(54) IMAGE RECOGNITION METHOD AND DEVICE

(71) Applicant: Panasonic Intellectual Property Management Co., Ltd., Osaka (JP)

(72) Inventors: TOMOKI AMANO, Osaka (JP); YASUHIKO SAKAI, Osaka (JP)

(21) Appl. No.: 19/306,834

(22) Filed: Aug. 21, 2025

Related U.S. Application Data
(63) Continuation of application No. PCT/JP2024/001674, filed on Jan. 22, 2024.

(30) Foreign Application Priority Data
Mar. 15, 2023 (JP) 2023-040720

(51) Int. Cl. G06V 10/141; G06T 7/50; G06T 7/90; H04N 23/74

(52) U.S. Cl. CPC G06V 10/141; G06T 7/50; G06T 7/90; H04N 23/74; G06T 2207/10024

(57) ABSTRACT

Provided is an image recognition method for recognizing and measuring an outer shape of transparent member (11) in object (2) having transparent member (11) disposed on a surface, and the method includes irradiating object (2) with illumination light (15) from illumination device (5) configured to perform irradiation of illumination light (15) with a plurality of illumination light intensities, the illumination light intensity having one illumination light intensity based on color information of transparent member (11), among the plurality of illumination light intensities and being within illumination angle θ at which the illumination light is configured to be totally reflected in transparent member (11), imaging object (2) irradiated with illumination light (15), and recognizing the outer shape of transparent member (11) based on imaged information.

### TECHNICAL FIELD

The present invention is an image recognition method and device that realizes outer shape recognition of an object regardless of color while removing glare of a peripheral portion of the object generated in a procedure of performing recognition by imaging using a camera.

### BACKGROUND ART

In recent years, an image recognition technology for recognizing an object from an image imaged by a camera has been utilized in various areas. For example, in a field of product manufacturing processes, the image recognition technology is used for measurement such as recognition of a defect or length measurement by appearance inspection.

In order to reliably recognize an object to be recognized, it is necessary to irradiate the object with illumination light by using an illumination device to increase sensitivity in imaging of the camera.

However, in the case of an object in which transparent glass is attached to one surface, illumination light, a surrounding structure, or the like tends to be reflected on an object surface depending on color immediately below glass. When the glare occurs in this manner, the accuracy of length measurement decreases when the length measurement of the object is recognized by using the imaged image.

PTL 1 proposes a method in consideration of the above problem. As a background of development of this method, in a manufacturing procedure of a battery electrode plate, there may be a case where a high gloss portion made of metal in which glare easily occurs and a low gloss portion made of resin in which glare hardly occur are simultaneously present. In such a case, PTL 1 is a method for realizing surface inspection by recognition while avoiding glare by selectively using two types of light rays such as using diffused light for the high gloss portion and using parallel light for the low gloss portion.

In FIG. 10, when exterior body 102 that is a low gloss region and electrode tabs 103a and 103b that are high gloss regions are inspected with respect to a rectangular thin secondary battery 101, parallel light illuminators L1 to L4 which generate parallel light and diffused light illuminator Lw which generates diffused light are disposed around thin secondary battery 101, and parallel light illuminators L1 to L4 and diffused light illuminator Lw are used in combination in accordance with a gloss level. As a result, imaging can be performed while suppressing glare.

### CITATION LIST

### Patent Literature

PTL 1: Japanese Patent No. 6570977

### SUMMARY OF THE INVENTION

An image recognition method according to one aspect of the present invention is an image recognition method for recognizing and measuring an outer shape of a transparent member in an object having the transparent member disposed on a surface of the object, and the method includes irradiating the object with illumination light from an illumination device configured to perform irradiation of the illumination light at a plurality of illumination light intensities, the illumination light having one illumination light intensity based on color information of the transparent member, among the plurality of illumination light intensities and being within an illumination angle at which the illumination light is configured to be totally reflected in the transparent member, imaging the object irradiated with the illumination light, and recognizing the outer shape of the transparent member based on information generated by the imaging.

An image recognition device according to another aspect of the present invention is an image recognition device that recognizes and measures an outer shape of a transparent member in an object having the transparent member disposed on a surface of the object, and the device includes an illumination device configured to perform irradiation of illumination light with a plurality of illumination light intensities, the illumination light having one illumination light intensity based on color information of the transparent member, among the plurality of illumination light intensities and being within an illumination angle at which the illumination light is configured to be totally reflected in the transparent member, a camera that images the object irradiated with the illumination light, and a calculation unit that recognizes the outer shape of the transparent member based on information generated by the camera.

### BRIEF DESCRIPTION OF THE DRAWINGS

FIG. 1 is a schematic diagram of an image recognition device according to an exemplary embodiment of the present invention.

FIG. 2 is a schematic view of an object according to the exemplary embodiment of the present invention.

FIG. 3 is a schematic diagram of a recognition system at the time of edge emphasis according to the exemplary embodiment of the present invention.

FIG. 4 is a diagram illustrating a result of length measurement recognition based on an illumination angle in glass at the time of edge emphasis imaging according to the exemplary embodiment of the present invention.

FIG. 5 is a diagram illustrating a result of recognition for each illumination light intensity applied to the center portion of a glass surface at the time of edge emphasis imaging according to the exemplary embodiment of the present invention.

FIG. 6 is a schematic diagram of a recognition system at the time of surface emphasis according to the exemplary embodiment of the present invention.

FIG. 7 is a diagram illustrating a result of recognition for each illumination light intensity applied to the center portion of the glass surface at the time of surface emphasis imaging according to the exemplary embodiment of the present invention.

FIG. 8 is a diagram illustrating a design part, various imaging methods, and results of length measurement recognition according to the exemplary embodiment of the present invention.

FIG. 9 is a flowchart of the recognition system according to the exemplary embodiment of the present disclosure.

FIG. 10 is an explanatory diagram schematically illustrating a layout of constituent elements of a surface inspection device described in PTL 1.

### DESCRIPTION OF EMBODIMENT

In the invention according to PTL 1, since diffused light has no straightness compared to parallel light, it is effective for glare present in the vicinity of illumination, but it is assumed that application in a situation where a large object or a plurality of objects needs to be simultaneously recognized is difficult. For example, in a case where recognition is to be performed under a situation where a wide variety of objects such as a recycling process are discharged, it is impossible to deploy a system corresponding to each object. Thus, it is desired to construct a system that can be recognized regardless of the presence or absence of a glare when considering application to a wide variety of products.

The present invention has been made to solve the above-described conventional problems, and an object of the present invention is to provide an image recognition method and an image recognition device that realize recognition in an identical illumination device by changing illumination light intensity of illumination light in accordance with color information of an object.

Hereinafter, an exemplary embodiment of the present invention will be described in detail below with reference to the drawings.

### EXEMPLARY EMBODIMENT

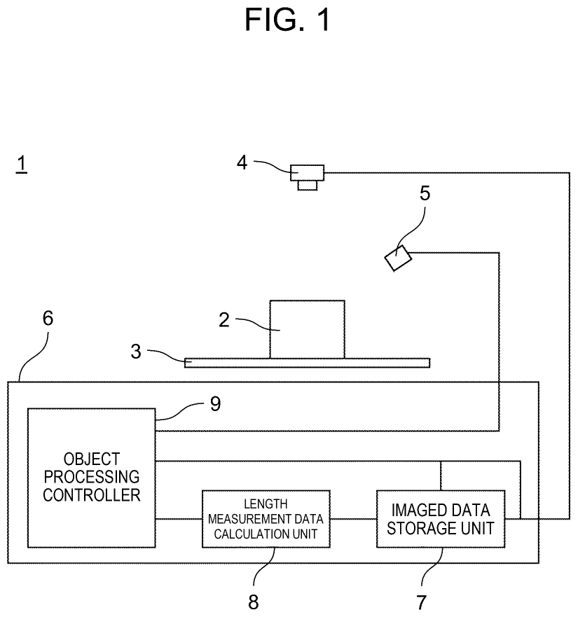

Image recognition device 1 according to the exemplary embodiment illustrated in FIG. 1 recognizes and measures an outer shape of transparent member 11 in object 2 in which transparent member 11 is disposed on a surface. Image recognition device 1 includes at least illuminator 5 as an example of an illumination device, camera 4 as an example of an imaging camera, and length measurement data calculation unit 8 as an example of a calculation unit.

Illuminator 5 is disposed obliquely above object 2, and is capable of irradiating object 2 with illumination light 15 at a variable illumination light intensity, that is, at a plurality of illumination light intensities, and irradiates object 2 with illumination light 15 at an illumination light intensity based on color information of transparent member 11 and within illumination angle θ at which the illumination light can be totally reflected in transparent member 11.

Camera 4 is disposed above object 2, and images the surface of object 2 irradiated with illumination light 15 to acquire image data.

Length measurement data calculation unit 8 recognizes the outer shape of transparent member 11 by calculation based on the imaged information.

More specifically, in addition to length measurement data calculation unit 8, image recognition device 1 includes recognition length measurement unit 6 having imaged data storage unit 7 and object processing controller 9, and also includes stage 3.

Imaged data storage unit 7 stores image data imaged by imaging camera 4.

Length measurement data calculation unit 8 calculates a length measurement result by using the image data stored in imaged data storage unit 7.

Object processing controller 9 can determine the illumination light intensity of illuminator 5 based on the color information of transparent member 11 and can perform control such that the illumination light intensity of illuminator 5 is changed to the determined illumination light intensity. Note that, object processing controller 9 may also perform color determination processing such as color recognition processing, as will be described later.

Here, the color information of transparent member 11 means model information of object 2, a color of design part 12 or base material 13 that transmits transparent member 11, a color of a bottom surface of the transparent member that transmits transparent member 11, a color of the transparent member itself, or a color by any combination thereof.

Object 2 can be mounted on stage 3.

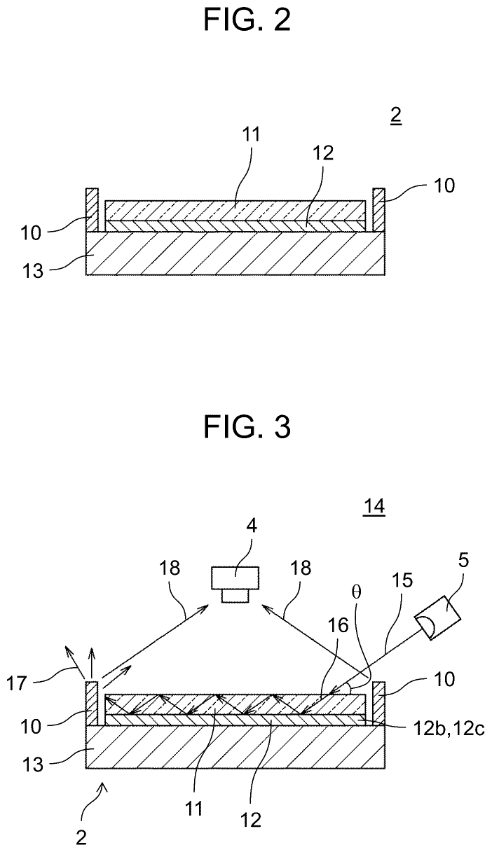

FIG. 2 is a schematic diagram of object 2 having a rectangular shape, for example. Transparent member 11 having, for example, a rectangular plate shape comes into close contact with at least one surface of design part 12, and base material 13 having, for example, a rectangular plate shape comes into close contact with a side where transparent member 11 is not present.

In addition, there is no problem only with transparent member 11 alone, but an end edge of transparent member 11 is surrounded by an edge 10 having a rectangular frame shape, and thus, it is possible to further clarify the outer shape of transparent member 11 at the time of recognition length measurement.

When the color information of transparent member 11 is color information of design part 12 that transmits transparent member 11, the color information of design part 12 includes color information of high reflection design 12a, color information of low reflection design 12b, and color information of mirror plane design 12c. With respect to a wavelength of illumination light 15 that is light emitted from illuminator 5, design part 12 can be classified into three types: high reflection design 12a that exhibits a reflectance of 50% or more and 100% or less inclusive when a reference reflectance is 50% and is not subjected to mirror plane processing; low reflection design 12b that exhibits a reflectance of 0% or more and less than 50%; and mirror plane design 12c that is subjected to mirror plane processing regardless of the reflectance.

The color information of high reflection design 12a is, for example, a color such as white that exhibits a reflectance of 50% or more with respect to light having a visible light wavelength.

The color information of low reflection design 12b is, for example, a color such as black or gray that exhibits a reflectance of less than 50% with respect to light having a visible light wavelength. Note that, the reference reflectance is not limited to 50%.

The color information of mirror plane design 12c is a color having a property of reflecting an object present around object 2 and at a position symmetrical to design part 12, such as a mirror.

In design part 12, a design is formed or colored by using various printing methods such as offset printing, gravure printing, or screen printing, or by coating.

Transparent member 11 is made of, for example, a glass material including soda glass, borosilicate glass, or the like, or a transparent resin material such as PMMA (acrylic), PET, polycarbonate (PC), or polyvinyl chloride (PVC). Transparent member 11 may be colorless and transparent, but the transparent member may be colored as long as most of illumination light 15 can be transmitted therethrough.

In image recognition device 1, an image forming method is different depending on a type of design part 12 described above.

The principle of various image forming methods will be described with reference to FIGS. 3 and 6.

FIG. 3 illustrates a schematic diagram of a recognition system in edge emphasis imaging 14 for low reflection design 12b or mirror plane design 12c. Edge emphasis imaging 14 is image forming in which edge 10 present around object 2 is floated. Imaging camera 4 images object 2. Illuminator 5 is used to generate illumination light 15. The illumination light totally reflected inside transparent member 11 is total reflection light 16. A light phenomenon in which total reflection light 16 emitted from an end portion of transparent member 11 is emitted at edge 10 becomes edge light emission 17. Of edge light emission 17, light emission that is imaged by imaging camera 4 is referred to as edge reflection.

In the case of edge emphasis imaging 14, it is necessary to determine an illumination angle of illuminator 5 according to a refractive index of transparent member 11. The illumination angle means angle θ formed by illumination light 15 from illuminator 5 and the surface of transparent member 11. In transparent member 11, total reflection light 16 is generated in transparent member 11 by the irradiation of illumination light 15, and thus, illumination light 15 propagates through transparent member 11 and leaks to edge light emission 17. Edge reflection 18 is imaged by imaging camera 4 by emphasizing edge 10 by leaked illumination light 15.

As the refractive index of transparent member 11, for example, in the case of glass, the refractive index was 1.5, and total reflection could be generated as long as illumination angle θ was within 45 degrees exceeding 0 degrees.

As necessary for length measurement recognition, the following evaluation was performed based on the absence of glare around object 2 and whether or not a contour of the edge could be generated.

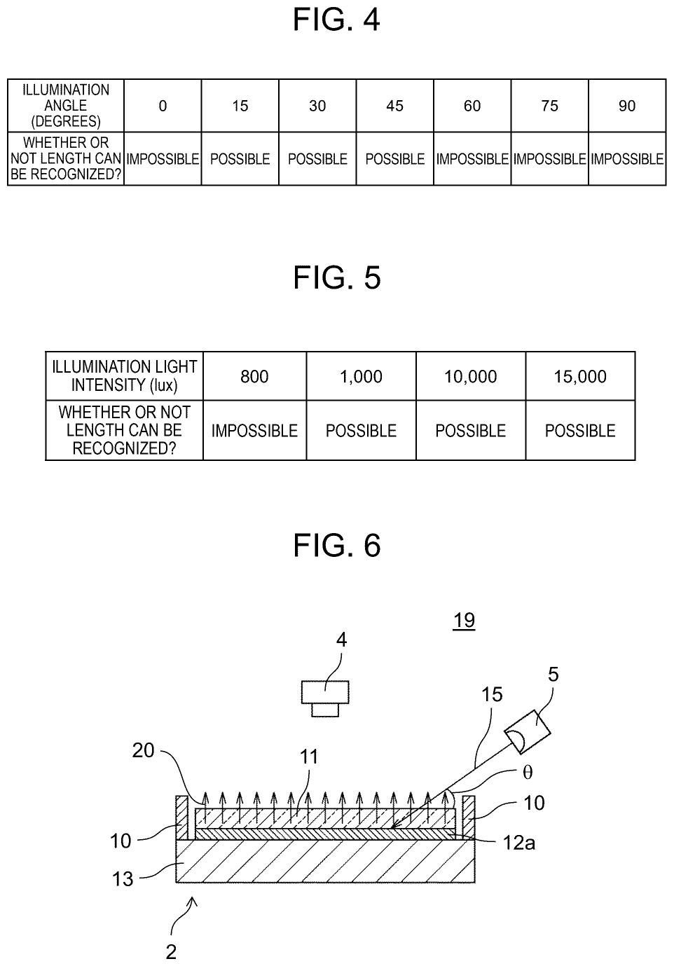

In FIG. 4, a length measurement recognition result based on a change in illumination angle θ in glass based on this evaluation was summarized.

From this result, it was necessary to set illumination angle θ of illuminator 5 to 15 to 45 degrees with respect to the surface of object 2. When illumination angle θ was 0 degrees, since the illumination light was not applied to object 2, object 2 could not be recognized. When illumination angle θ was 60 degrees or more, since total reflection did not occur in the glass and glare of surrounding structures was present, the object could not be recognized.

In addition, FIG. 5 illustrates a length measurement recognition result based on the evaluation due to a change in the illumination light intensity of illumination light 15 with which the surface of object 2 is irradiated. Illumination angle θ was fixed to 30 degrees.

From this result, it was found that it was necessary to install illuminator 5 such that the illumination light intensity on the surface of object 2 was 1,000 (lux) to 15,000 (lux). At an illumination light intensity of 800 (lux), an image was not formed because the illumination light intensity was insufficient.

FIG. 6 is a schematic diagram of a recognition system in surface emphasis imaging 19 for high reflection design 12a. Although having a configuration similar to edge emphasis imaging 14, there is no glare when illumination light 15 is irradiated, and design surface reflection 20 in which a color of high reflection design 12a is imaged as it is is formed.

When illumination angle θ at which object 2 can be irradiated with illumination light 15 is from 0 degrees to 90 degrees inclusive, an image can be formed without any problem. Transparent member 11 is irradiated with illumination light 15, and thus, high reflection design 12a reflects illumination light 15, and a surface itself floats to form an image like design surface reflection 20.

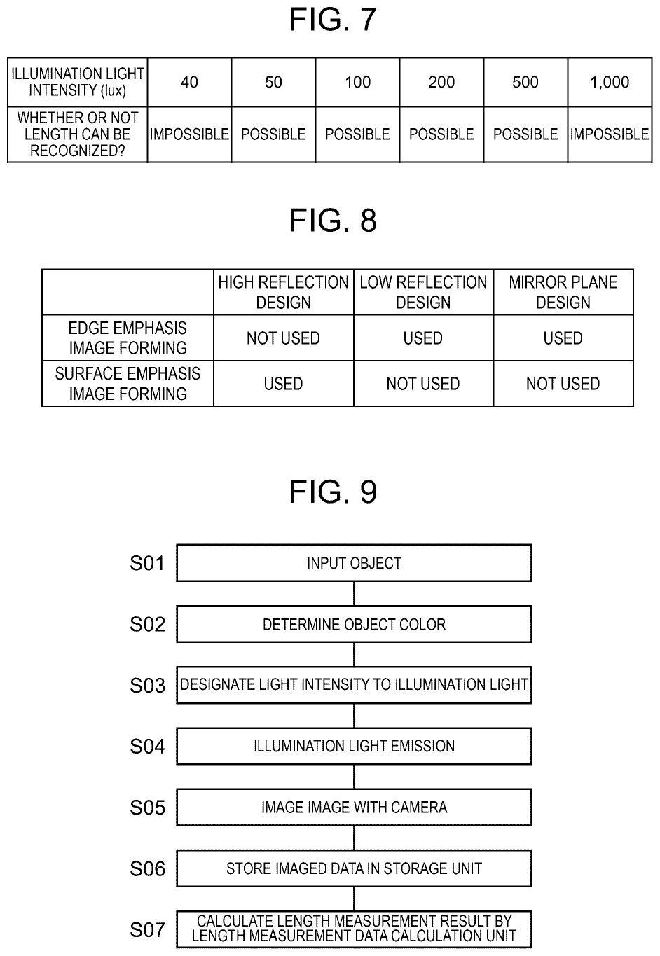

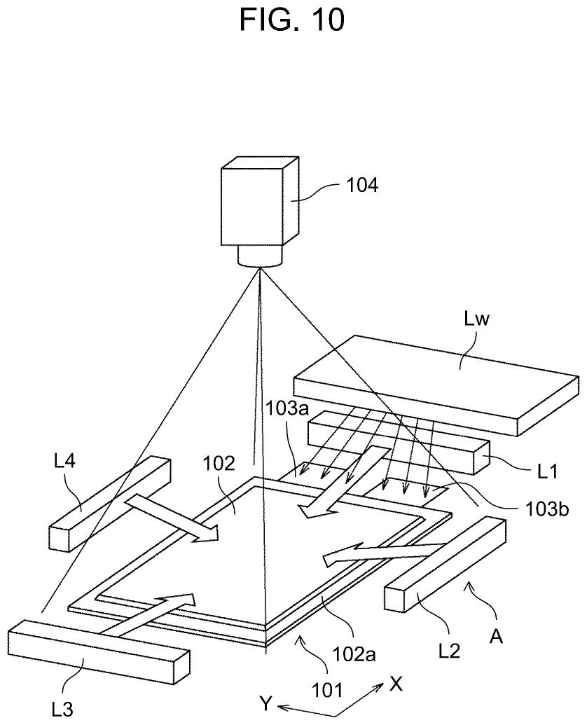

FIG. 7 illustrates a length measurement recognition result based on the illumination light intensity of illumination light 15 with which the surface of object 2 is irradiated based on the evaluation. Illumination angle θ was fixed to 30 degrees.

From this result, it was found that it was necessary to install illuminator 5 such that the illumination light intensity on the surface of object 2 was 50 (lux) to 500 (lux). At an illumination light intensity of 40 (lux), an image was not formed because the illumination light intensity was insufficient. In addition, at an illumination light intensity of 1,000 (lux), since the surface of object 2 was too bright, surface expansion occurred. As a result, the object could not be recognized.

The illumination light intensity needs to be more than or equal to 1000 (lux) in edge emphasis imaging 14, but the illumination light intensity needs to be less than or equal to 500 (lux) in surface emphasis imaging 19. Thus, in order to make the length measurement recognition coexist in an identical configuration, it is desirable that illuminator 5 having a function of switching the illumination light intensity based on the illumination light intensity is provided.

It can be seen from the present exemplary embodiment that required illumination light intensity is different between edge emphasis imaging 14 and surface emphasis imaging 19. Thus, it is desirable that image recognition device 1 having a function of switching the illumination light intensity as a function of the present exemplary embodiment is provided.

FIG. 8 illustrates that in the present exemplary embodiment, an image forming method is different depending on a type of design of design part 12. Edge emphasis imaging 14 is used for imaging low reflection design 12b and mirror plane design 12c. Surface emphasis imaging 19 is used for imaging high reflection design 12a.

FIG. 9 is a flowchart according to the exemplary embodiment.

First, in step S01, object 2 is disposed at a predetermined position on stage 3.

Subsequently, in step S02, as an example, in a case where the color information of transparent member 11 is the color of design part 12 that transmits transparent member 11, object processing controller 9 determines which or not one of high reflection design 12a, low reflection design 12b, and mirror plane design 12c is selected from the color of design part 12. At this time, object 2 is imaged by camera 4, and color recognition is performed by object processing controller 9. Thus, the color information of design part 12 can be acquired.

As an example of a method for determining design in object processing controller 9, there is a method for creating a database for determining object 2 for each color of three types of designs 12a, 12b, and 12c in advance and determining object 2 as high reflection design 12a when object 2 is white as a result of color recognition, low reflection design 12b when object 2 is black or gray, and the like by using the database. Alternatively, there is a method of determining the object by using the color information of design part 12 included in the model information of object 2 and the database. Alternatively, it can be determined by RGB of design part 12 in the color recognition. Alternatively, object 2 is imaged by camera 4, the reflectance is measured, and the determination can be made from a database indicating a relationship between the reflectance and the three types of designs based on the measured reflectance. Further, instead of the color information of design part 12, the color information of transparent member 11 may be color information of base material 13 that transmits transparent member 11, color information of a bottom surface of the transparent member that transmits transparent member 11, color information of the transparent member itself, or color information by any combination thereof.

Subsequently, in step S03, object processing controller 9 designates the illumination light intensity determined in advance by the color or design of object 2 determined by object processing controller 9 in step S02.

Subsequently, in step S04, illuminator 5 irradiates the surface of object 2 with illumination light 15 at the illumination light intensity designated in step S03.

Subsequently, in step S05, object 2 irradiated with illumination light 15 at the illumination light intensity is imaged by imaging camera 4.

Subsequently, in step S06, image data imaged by imaging camera 4 in step S05 is stored in imaged data storage unit 7.

Subsequently, in step S07, by using the image data stored in imaged data storage unit 7, length measurement data calculation unit 8 calculates the length measurement result to recognize the outer shape of transparent member 11. For example, the following recognition flow processing is performed to calculate the length measurement result. First, a color image imaged by camera 4 is acquired, and then gray image conversion processing is performed to convert the color image into a gray image. Subsequently, contrast processing is performed to clarify the image. Subsequently, differential processing is performed to display the contour. Subsequently, two-stage binarization processing is performed to remove noise. Subsequently, extraction processing is performed on the outer shape portion of transparent member 11 to detect a size and a position of the outer shape. At this time, outliers are removed depending on the detected size and position of the outer shape, and the outer shape is finally recognized.

As described above, in accordance with an image recognition method and device according to the exemplary embodiment, the recognition in identical illuminator 5 can be realized by changing the illumination light intensity of illumination light 15 according to the color information of object 2. In accordance with the present exemplary embodiment, the illumination light intensity of illumination light 15 is changed according to the color information of object 2, and thus, it is possible to suppress diffused reflection on the object surface, which is a factor of glare. As a result, it is possible to emphasize edge 10 of object 2 in low reflection design 12b or mirror plane design 12c. In high reflection design 12a having a high light reflectance at an illumination light wavelength, the illumination light intensity is set to be smaller than those of other designs 12b and 12c, and thus, the outer shape of object 2 can be accurately recognized while light expansion is suppressed. As a result, it is possible to realize length measurement in which the outer shape can be recognized for a wide variety of colors of object 2.

Note that, any appropriate combination of the various exemplary embodiments or modifications described above enables effects of the respective exemplary embodiments or modifications to be achieved. Additionally, combinations of exemplary embodiments, combinations of examples, or combinations of exemplary embodiments and examples are possible, and combinations of features in different exemplary embodiments or examples are also possible.

As described above, in accordance with the image recognition method and device according to the above aspect of the present invention, the recognition in the identical illumination device can be realized by changing the illumination light intensity of the illumination light according to the color information of the object.

### INDUSTRIAL APPLICABILITY

The image recognition method and device according to the above aspect of the present invention can realize the recognition in the identical illumination device by changing the illumination light intensity of the illumination light according to the color information of the object, and is useful, for example, in a case where recognition is to be performed under a situation where a wide variety of objects such as a recycling process are increasing every day.

### REFERENCE MARKS IN THE DRAWINGS

1 image recognition device
2 object
3 stage
4 imaging camera
5 illuminator
6 recognition length measurement unit
7 imaged data storage unit
8 length measurement data calculation unit
9 object processing controller
10 edge
11 transparent member
12 design part
12a high reflection design
12b low reflection design
12c mirror plane design
13 base material
14 edge emphasis imaging
15 illumination light
16 total reflection light
17 edge light emission
18 edge reflection
19 surface emphasis imaging
20 design surface reflection

1. An image recognition method for recognizing and measuring an outer shape of a transparent member in an object having the transparent member disposed on a surface of the object, the method comprising:
irradiating the object with illumination light from an illumination device configured to perform irradiation of the illumination light at a plurality of illumination light intensities, the illumination light having one illumination light intensity based on color information of the transparent member, among the plurality of illumination light intensities and being within an illumination angle at which the illumination light is configured to be totally reflected in the transparent member;
imaging the object irradiated with the illumination light; and
recognizing the outer shape of the transparent member based on information generated by the imaging.

2. The image recognition method according to claim 1, wherein, when the irradiating of the illumination light is performed, the illumination angle of the illumination light incident on the surface of the object is from 15 degrees to 45 degrees inclusive.

3. The image recognition method according to claim 1,
wherein the color information of the transparent member is color information of a design part disposed between the transparent member of the object and a base material,
the color information of the design part has
color information of a high reflection design that exhibits a reflectance from a reference reflectance to 100% inclusive with respect to a wavelength of the illumination light emitted from the illumination device and is not subjected to mirror plane processing,
color information of a low reflection design that exhibits a reflectance of 0% or more and less than the reference reflectance, and
color information of a mirror plane design on which mirror plane processing is performed regardless of the reflectance, and
an illumination light intensity of each of the color information of the low reflection design and the color information of the mirror plane design is larger than an illumination light intensity of the color information of the high reflection design.

4. The image recognition method according to claim 3, wherein, when the irradiation of the illumination light is performed, the illumination light intensity of each of the color information of the low reflection design and the color information of the mirror plane design is from 1,000 (lux) to 15,000 (lux) inclusive, and the illumination light intensity of the color information of the high reflection design is 50 (lux) to 500 (lux).

5. An image recognition device that recognizes and measures an outer shape of a transparent member in an object having the transparent member disposed on a surface of the object, the device comprising:
an illumination device configured to perform irradiation of illumination light with a plurality of illumination light intensities, the illumination light having one illumination light intensity based on color information of the transparent member, among the plurality of illumination light intensities and being within an illumination angle at which the illumination light is configured to be totally reflected in the transparent member;
a camera that images the object irradiated with the illumination light; and
a calculation unit that recognizes the outer shape of the transparent member based on information generated by the camera.

6. The image recognition device according to claim 5, wherein, in the illumination device, the illumination angle of the illumination light incident on the surface of the object is from 15 degrees to 45 degrees inclusive.

7. The image recognition device according to claim 5,
wherein the color information of the transparent member is color information of a design part disposed between the transparent member of the object and a base material,
the color information of the design part has
color information of a high reflection design that exhibits a reflectance from a reference reflectance to 100% inclusive with respect to a wavelength of the illumination light emitted from the illumination device and is not subjected to mirror plane processing,
color information of a low reflection design that exhibits a reflectance of 0% or more and less than the reference reflectance, and
color information of a mirror plane design on which mirror plane processing is performed regardless of the reflectance, and
an illumination light intensity of each of the color information of the low reflection design and the color information of the mirror plane design is larger than an illumination light intensity of the color information of the high reflection design.

8. The image recognition device according to claim 7, wherein, in the illumination device, the illumination light intensity of each of the color information of the low reflection design and the color information of the mirror plane design is from 1,000 (lux) to 15,000 (lux) inclusive, and the illumination light intensity of the color information of the high reflection design is 50 (lux) to 500 (lux).
